(19) United States
(12) Patent Application Publication
(10) Pub. No.: US 2004/0205587 A1
(43) Pub. Date: Oct. 14, 2004

(54) System and method for enumerating arbitrary hyperlinked structures in which links may be dynamically calculable

(76) Inventor: Stephen P.W. Draper, Basingstoke (GB)

Correspondence Address: ERIC B. MEYERTONS, CONLEY, ROSE & TAYON, P.C., P.O. BOX 398, AUSTIN, TX, 78767-0398, US

(21) Appl. No.: 10/200,025

(22) Filed: Jul. 19, 2002

Related U.S. Application Data
(60) Provisional application No. 60/310,627, filed on Aug. 7, 2001.

(51) Int. Cl. G06F 15/00; G06F 17/24

(52) U.S. Cl. 715/513; 715/501.1

(57) ABSTRACT

A system and method for dynamically enumerating the links in arbitrary hyperlinked data structures using parsing rules are provided. A hyperlinked data structure may be enumerated by reading one or more data objects through an object access interface, parsing the one or more data objects in the data structure, identifying two or more data elements in the one or more data objects, combining one or more data elements to obtain one or more hyperlink addresses, and reading the one or more hyperlink addresses to enumerate the one or more data objects. In one embodiment, hyperlinked structures such as Websites, may be enumerated using configuration templates. The templates may include heuristic parsing rules. The definition of the templates may be independent of the evolution of the data objects over time.

### PRIORITY CLAIM

This application claims the benefit of U.S. Provisional Patent Applications serial No. 60/310,627 to Stephen P. W. Draper entitled “SYSTEM AND METHOD FOR ENUMERATING ARBITRARY HYPERLINKED STRUCTURES IN WHICH LINKS MAY BE DYNAMICALLY CALCULABLE” filed Aug. 7, 2001.

### BACKGROUND OF THE INVENTION

1. Field of the Invention

Embodiments presented herein generally relate to systems and methods for enumerating components of arbitrary hyperlinked data structures. Certain embodiments relate to systems and methods for dynamically enumerating the links in arbitrary hyperlinked data structures using parsing rules.

2. Description of the Related Art

Hyperlinked data structures are widely used in information presentation, for example, on Web pages as employed on the World Wide Web. Furthermore, it is frequently desirable to programmatically enumerate such structures (e.g., walking a Website with the goal of caching all its linked pages). In many such cases, the hyperlinks embedded in data objects such as Web pages are not statically embedded addresses but are determined at the time the structure is navigated. The term “page” will be used interchangeably with “data object” in this context. In the Web case, navigation of hyperlinked data structures is the process of “browsing”. Typically, this dynamic construction is mediated by embedded code (such as Java applets) or embedded scripts (such as JavaScript or VBScript). An example might be the implementation of a dynamic menu system used for navigation of a Website. Target addresses of different user selections from such a menu may be determined by means such as lookup from a script-initialized array.

There are several existing methods of navigating hyperlinked data structures. The first is static parsing of the non-active (script and code) structures of pages (e.g., HTML or XML parsers). Static parsing identifies only statically embedded hyperlinks. Therefore, only a subset of all structures, i.e., structures reachable without the use of dynamically determined links, are enumerated. In a Website example, pages linked via dynamic navigation systems such as script-mediated menuing systems will not be enumerated with static parsing.

Another method is user-mediated navigation of a structure that relies on a human user to find available hyperlinks through behavioral manipulation of the presented page(s). Therefore, the presence of a human user is required to enumerate the data structure in user-mediated systems.

In addition, a user-simulator may be used to navigate hyperlinked data structures. An example is a higher-level programmatic entity that simulates the action of clicking on all regions of a presented Web page in a browser. In systems that rely upon a user-simulator, the semantics of navigation are not apparent. Therefore, such systems are not capable of enumerating links that require complex manipulation of the user interface. An example of a system not capable of enumerating links may be a menu system that contains child menus. The first click on a parent menu may change the navigational semantics of a subsequent click (on a child-menu in this case). Such sequential interactions between user actions may lead to an explosion of the number of possible action paths, which a user simulator must seek to follow, thereby, rendering this approach impractical.

Finally, parsing and subsequent static analysis of embedded code/scripts may be used to determine the possible links that may be generated. Static analysis of embedded code may lead to two principal difficulties. The first difficulty is associated with parsing all employed coding mechanisms. For example, in the case of Websites, built-in obsolete coding may be a problem since the emergence of new coding schemes (e.g., new versions of scripting languages) is a frequent process. An additional extremely complex problem may arise when embedded code is intended for direct execution rather than parsing. For example, since both Java and ActiveX code are compiled rather than interpreted, semantic parsing is extremely difficult.

The second difficulty with static analysis of embedded code is associated with determining the behavior a program will exhibit when run by static analysis. This is a well-known and currently unsolvable problem in computer science in the general case. Hence, in the fully general case, this approach is currently incomplete.

### SUMMARY OF THE INVENTION

Embodiments presented herein relate to a system and method for enumerating arbitrary hyperlinked structures. A hyperlinked data structure may be enumerated by reading one or more data objects through an object access interface. Enumerating a hyperlinked data structure may also include parsing the one or more data objects in the data structure. One or more data elements may then be identified in the one or more data objects. Next, one or more data elements may be combined to obtain one or more hyperlink addresses. Finally, the one or more hyperlink addresses may be read to enumerate the one or more data objects.

In one embodiment, the system and method may use configuration templates that include parsing rules. The rules may be based on heuristics. The configuration template may be a function of the implementation style of a Website that includes hyperlinked data structures, rather than of the particular content of the Website, i.e., it may be structural rather than content-specific. Thus, such templates may include a single operation for a particular structure independent of the evolution of the data objects within that structure over time.

In one embodiment, a system for enumerating a hyperlinked data structure may include a network, a CPU coupled to the network, and a system memory coupled to the CPU. The system memory may store one or more computer programs executable by the CPU. The computer programs may be executable to read one or more data objects through an object access interface and parse the one or more data objects in the data structure. The computer programs may then be executable to identify one or more data elements in the one or more data objects and combine one or more data elements to obtain one or more hyperlink addresses. The computer programs may also be executable to read the one or more hyperlink addresses to enumerate the one or more data objects. In one embodiment, a carrier medium may store program instructions that are executable to implement enumerating a hyperlinked data structure on a computer system.

### BRIEF DESCRIPTION OF THE DRAWINGS

Other objects and advantages will become apparent upon reading the following detailed description and upon reference to the accompanying drawings in which:

FIG. 1 is a network diagram of an embodiment of a wide area network suitable for implementing various embodiments;

FIG. 2 is an illustration of an embodiment of a computer system suitable for implementing various embodiments; and

FIG. 3 is a block diagram indicating an embodiment of data flow and major processing modules.

While the invention is susceptible to various modifications and alternative forms, specific embodiments thereof are shown by way of example in the drawings and will be described in detail herein. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

As used herein, the term “hyperlink” refers to an element in an electronic document that links to another place in the same document or to an entirely different document. Typically, a user selects a hyperlink to follow the link. Hyperlinks are the most essential element of all hypertext systems such as the World Wide Web.

The term “Web browser” or “browser” generally refers to a software application used to locate and display Web pages. Two of the most popular browsers are Netscape Navigator and Microsoft Internet Explorer. Both of these browsers are graphical browsers, which means that they can display graphics as well as text. In addition, most modern browsers can present multimedia information such as sound and video.

The term “World Wide Web” generally refers to a system of Internet servers that support specially formatted documents. The documents are typically formatted in a language, called HyperText Markup Language (“HTML”) that supports links to other documents, graphics, audio, and video files. Not all Internet servers are part of the World Wide Web.

The term “HTML” is a language used to create documents on the World Wide Web. HTML defines the structure and layout of a Web document by using a variety of tags and attributes.

The term “XML” is an acronym for “Extensible Markup Language”, which generally refers to a specification developed by the World Wide Web Consortium (W3C). The W3C is an international consortium of companies involved with the Internet and the Web.

The term “URL” is an abbreviation of “Uniform Resource Locator”, which generally refers to the global address of documents and other such resources that may be available on the World Wide Web.

The term “data structures” in programming refers to a scheme for organizing related pieces of information. The basic types of data structures include, but are not limited to, files, lists, arrays, records, trees, and tables.

The term “dynamic” refers to actions that take place at the moment they are needed or requested rather than in advance. For example, many programs perform dynamic memory allocation, which means that such programs do not allocate memory ahead of time. In contrast, such programs allocate sections of memory when needed or requested. The term “static” is generally defined as the opposite of dynamic.

“Script” is another term for macro or batch file. A script generally refers to a list of commands that may be executed without user interaction. A script language is a simple programming language used to write scripts.

The term “code” refers to a set of instructions for a computer. The set of instructions may include symbols such as letters or numbers used to represent assigned meanings.

The term “cache” refers to a special high-speed storage mechanism. It can be either a reserved section of main memory or an independent high-speed storage device. Two types of caching commonly used in personal computers include memory caching and disk caching.

The term “object” refers generally to any item that can be individually selected and manipulated. An object may include shapes and pictures that appear on a display screen as well as less tangible software entities. In object-oriented programming, for example, an object is a self-contained entity that includes both data and procedures to manipulate the data.

The term “parse” generally refers to dividing language into smaller components that may be analyzed. For example, parsing this sentence would involve dividing it into components such as words and phrases and identifying the type of each component (e.g., verb, adjective, or noun). In computer science, typically any application that processes complex commands must be able to parse the commands. Such applications include virtually all end-user applications. Parsing may be divided into lexical analysis and semantic parsing. Lexical analysis includes dividing strings into components, called tokens, based on punctuation and other keys. Semantic parsing includes determining the meaning of the divided strings.

The term “regular expression” refers to a known notation for describing the rules by which sequences of characters in a string may be parsed into tokens using simple lexical patterns.

The term “concatenation” refers to the act of linking together two or more objects.

The term “queue” means to line up. In computer science, queuing refers to lining up jobs for a computer or device.

“Compile” refers to transforming a program written in a high-level programming language from source code into object code. For example, programmers write programs in a form called source code. Such source code must go through several steps before it becomes an executable program. The first step is to pass the source code through a compiler, which translates the high-level language instructions into object code.

As used herein, the term “functional transformation” generally refers to a process of converting object code into a higher-level code, such as, but not limited to a human readable programming language. For example, a functional transformation may be used to separate data (e.g., values, parameters, etc.) from functions (e.g., commands, logical operators, etc.).

The term “heuristics” refers to common-sense rules drawn from experience to solve problems. Heuristics may be contrasted with algorithmic programming, which is based on mathematically provable procedures. Heuristic programs include programs that are self-learning, which may get better with experience.

The term “applet” refers to a program executed from within another application.

The term “Java” refers to a high-level programming language developed by Sun Microsystems. Java is a general purpose programming language with a number of features that make the language well suited for use on the World Wide Web.

The term “JavaScript” refers to a scripting language developed by Netscape to enable Web authors to design interactive sites.

The term “VBScript”, short for “Visual Basic Scripting Edition”, refers to a scripting language developed by Microsoft and supported by Microsoft's Internet Explorer Web browser. VBScript is based on the Visual Basic programming language but is much simpler. It enables Web authors to include interactive controls such as buttons and scrollbars on their Web pages.

The term “ActiveX” refers to a loosely defined set of technologies developed by Microsoft. ActiveX is an outgrowth of two other Microsoft technologies called Object Linking and Embedding (“OLE”) and Component Object Model (“COM”).

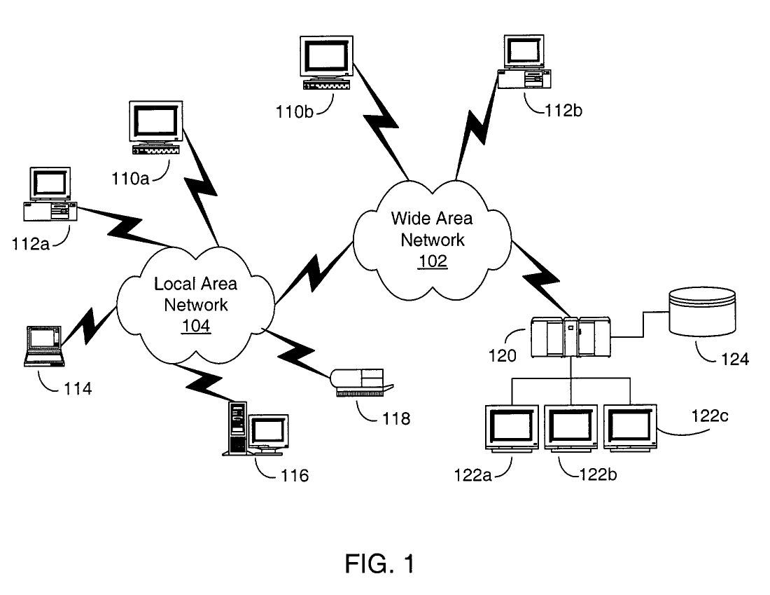

FIG. 1 illustrates a wide area network (“WAN”) according to one embodiment. WAN 102 is a network that spans a relatively large geographical area. The Internet is an example of WAN 102. WAN 102 includes a plurality of computer systems which are interconnected through one or more networks. Although one particular configuration is shown in FIG. 1, WAN 102 may include a variety of heterogeneous computer systems and networks interconnected in a variety of ways, and which run a variety of software applications.

One or more local area networks (LANs) 104 may be coupled to WAN 102. LAN 104 is a network that spans a relatively small area. Typically, LAN 104 may be confined to a single building or group of buildings. Each node (i.e., individual computer system or device) on LAN 104 may have its own CPU with which it executes programs. In addition, each node may be able to access data and devices anywhere on LAN 104. LAN 104, thus, may allow many users to share devices (e.g., printers) and/or data stored on file servers. LAN 104 may be characterized by a variety of types of topology (i.e., the geometric arrangement of devices on the network), of protocols (i.e., the rules and encoding specifications for sending data and whether the network uses a peer-to-peer or client/server architecture), and of media (e.g., twisted-pair wire, coaxial cables, fiber optic cables, radio waves).

Each LAN 104 may include a plurality of interconnected computer systems and optionally one or more other devices such as one or more workstations 110a, one or more personal computers 112a, one or more laptop or notebook computer systems 114, one or more server computer systems 116, and one or more network printers 118. As illustrated in FIG. 1, an example LAN 104 may include computer systems 110a, 112a, 114, and 116, and printer 118. LAN 104 may be coupled to other computer systems and/or other devices and/or other LANs 104 through WAN 102.

One or more mainframe computer systems 120 may be coupled to the WAN 102. As shown, mainframe 120 may be coupled to a storage device or file server 124 and mainframe terminals 122a, 122b, and 122c. The mainframe terminals 122a, 122b, and 122c may be configured to access data stored in the storage device or file server 124 coupled to or included in mainframe computer system 120.

WAN 102 may also include computer systems connected to WAN 102 individually and not through LAN 104, such as for purposes of example, workstation 110b and personal computer 112b. For example, WAN 102 may include computer systems that are geographically remote and connected to each other through the Internet.

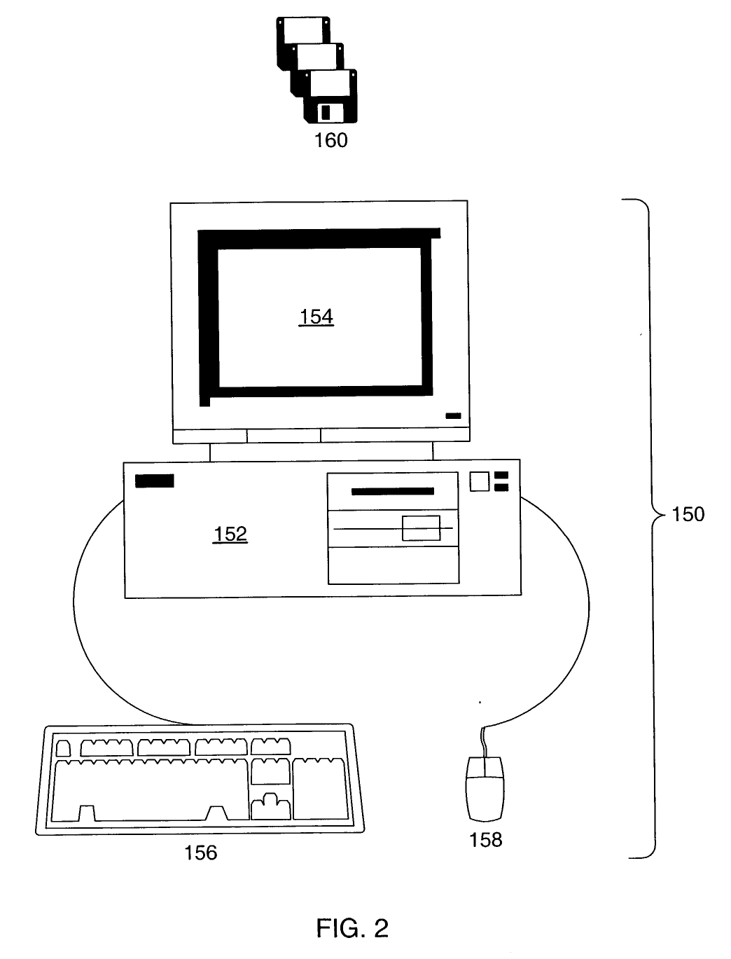

FIG. 2 illustrates an embodiment of computer system 150, which may be suitable for implementing various embodiments of a system and method for enumerating components of arbitrary hyperlinked data structures. Computer system 150, typically, includes components such as CPU 152 with an associated memory medium such as floppy disks 160. The memory medium may store program instructions for computer programs. The program instructions may be executable by CPU 152. Computer system 150 may further include a display device such as monitor 154, an alphanumeric input device such as keyboard 156, and a directional input device such as mouse 158. The computer system 150 may be operable to execute the computer programs to implement a method for enumerating components of arbitrary hyperlinked data structures as described herein.

Computer system 150 may include a memory medium on which computer programs according to various embodiments may be stored. The term “memory medium” generally refers to an installation medium, e.g., a CD-ROM or floppy disks 160, a computer system memory such as DRAM, SRAM, EDO RAM, Rambus RAM, etc., or a non-volatile memory such as a magnetic media, e.g., a hard drive or optical storage. The memory medium may also include other types of memory, or combinations thereof. In addition, the memory medium may be located in a first computer in which the programs are executed or may be located in a second different computer, which connects to the first computer over a network. In the latter instance, the second computer provides the program instructions to the first computer for execution. Also, computer system 150 may take various forms, including a personal computer system, mainframe computer system, workstation, network appliance, Internet appliance, personal digital assistant (“PDA”), television system, or other device. In general, the term “computer system” may be broadly defined to encompass any device having a processor, which executes instructions from a memory medium.

The memory medium may preferably store a software program or programs for enumerating components of arbitrary hyperlinked data structures as described herein. The software program(s) may be implemented in any of various ways including, but not limited to, procedure-based techniques, component-based techniques, and/or object-oriented techniques. For example, the software program may be implemented using ActiveX controls, C++ objects, JavaBeans, Microsoft Foundation Classes (“MFC”), browser-based applications (e.g., Java applets), traditional programs, or other technologies or methodologies as desired. A CPU such as host CPU 152 executing code and data from the memory medium may include a means for creating and executing the software program or programs according to the methods and/or block diagrams as described herein.

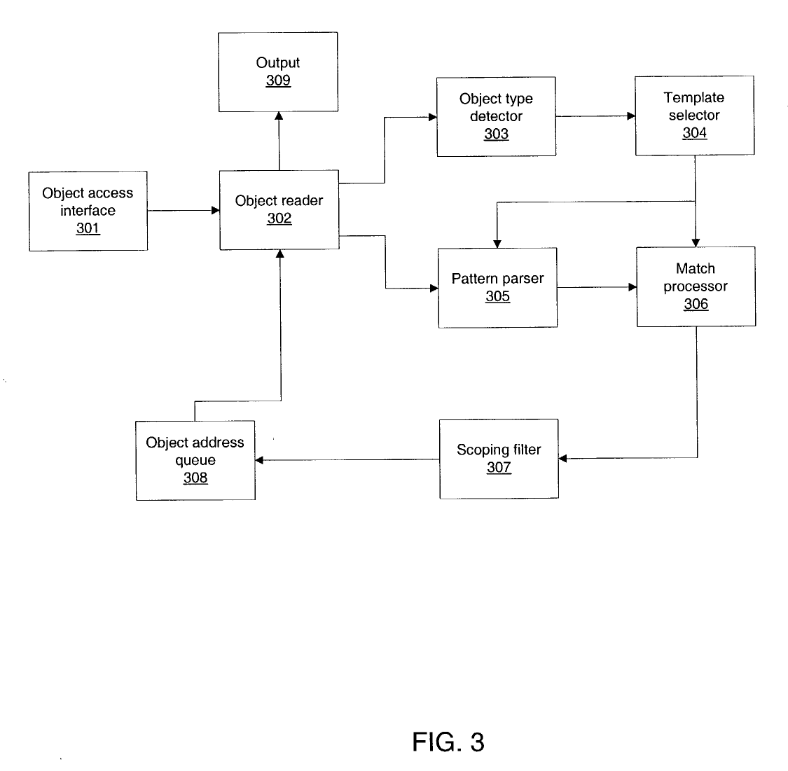

FIG. 3 illustrates an embodiment of a block diagram indicating data flow and major processing modules. As shown in FIG. 3, object address queue 308 may maintain a first list of data object addresses that are known to be part of the structure to be enumerated, but which have not yet been processed by data object reader 302. Object address queue 308 may also maintain a second list of data object addresses that have already been processed and may be initialized as an empty list. Addresses may be transferred from the first list to the second list when object reader 302 begins reading them.

In one embodiment, a root data object address may be provided to object address queue 308 to initiate the process by some external action. For example, the root data object address may be the home page of a Website. Generally, such initialization may take place with one or more of such root data objects.

Object reader 302 may read data objects through object access interface 301 by taking one object at a time from object address queue 308. The implementation of the interface may involve reading objects over a network (e.g., Web pages from their URLs) or from disk storage (e.g., files from their filenames). In one embodiment, data object reader 302 and data object access interface 301 may ignore object addresses that may not be resolved to an actual data object. In such cases, the object may be treated as empty and no data may be sent to either pattern parser 305 or object type detector 303.

Object type detector 303 may determine the type of data object read (e.g., HTML page). The type of data object read may be used by template selector 304 to select appropriate configuration templates. The mapping of object type to template instance may be a configuration choice of the system. A default template may be used for types for which explicit mappings have not been set up. In one embodiment, all types may use a single default template.

Pattern parser 305 may parse the read data object according to the rules encoded by the selected template. The templates may include a set of parsing rules that may be based on heuristics. Pattern parser 305 may identify data elements within the data object that match parsing rules specified in that template. These matching elements may be passed to match processor 306. Match processor 306, guided by rules contained in the selected template, may combine the set of parsed data elements with one another or with information from the selected template to produce one or more hyperlink addresses. The information from the selected template may be fixed data elements. Alternatively, the parsed data elements may be used directly as one or more hyperlink addresses. The one or more hyperlink addresses may be fed via scoping filter 307 back to object address queue 308. The hyperlink addresses may be read iteratively by object reader 302 to enumerate all objects within the structure. In some embodiments, two or more hyperlink addresses may be read and enumerated in parallel by object reader 302. Object address queue 308 may not enqueue addresses that are already in either its processed or unprocessed lists to prevent looping. The enumerated hyperlinked objects may be directed to output 309 from object reader 302.

Scoping filter 307 may use rules contained in the configuration template to determine whether the generated hyperlink is within the desired scope of enumeration. For example, a scoping filter that allows all links to be passed on would transitively iterate the entire structure. Typically, however, some scope may be imposed. For example, an imposed scope may include confinement within a set of domains when enumerating a Website.

In one embodiment, the rules defined by a template may specify a parsing of the data object to identify data elements of identified types and a process by which identified elements may be combined to produce hyperlink addresses. In one embodiment, a parsing of the data object to identify data elements of identified types may itself be a parser. An example of such a case may be to specify a standard HTML parser to parse out static links. In this example, only pages of the structure reachable via static links may be enumerated. The result is degenerate to direct use of an HTML parser as embodied in previous systems.

In one embodiment, a process by which identified elements may be combined to produce hyperlink addresses may be provided by an arbitrary code such as JavaScript embedded in the template. Alternatively, a process, which uses rules defined to allow identified elements to be combined with each other may be used with statically defined elements in the template by simple lexical manipulation such as concatenation.

In one embodiment, a configuration template may include parsing rules that are defined in terms of regular expressions to be matched against the data included in a data object. The rules for combining elements may be lexical rules that may include the definition of stored symbols built from data elements already parsed in the processing of a data object. Each parsing rule may include a regular expression and a data element type identifier. The regular expression may identify a pattern to be found in the data including a data object and a subset of that match as a data element value. Special rules may be defined for the beginning and end of the data object. The data element type identifies the rule used to generate the match.

In one embodiment, the combination rules may be directly associated with the data element types identified by the parsing rules. Any combination rules associated with a particular parsed data element type may be applied to that data element type as it is presented. The rules may specify any determined value obtained by concatenation of defined symbols, static values from the rule itself, and any identified data element value. The concatenation may be filtered by a rule-defined regular expression to match some substring of the concatenation result that is the final value. The rules may also specify to store the determined value as an identified symbol for use by subsequent rule processing. In addition, the rules may specify to output the determined value as a determined hyperlink address.

The embodiments disclosed herein may be applied to the following example of a section of JavaScript embedded in a Web page that may be used to provide part of the functionality of a navigation system:

page_base = ‘\navigation_targets’;
...
TargetArray[0] = ‘target_page1.html’;
TargetArray[1] = ‘target_page2.html’;
...
function onSelectTarget (n)
{

goto_url( page_base + ‘/’ + TargetArray[in] );

}

The section of script is an example of the manner in which a target hyperlink address may be constructed at runtime. In this case, the function onSelectTarget causes the browser to navigate to a URL specified by a parameter that is interpreted as the index of an array. The form (structure) of the script may be unaffected by the addition or change of menu navigation targets. A configuration template may be written to parse the page_base value and each of the TargetArray element values out of the script and to produce the same hyperlink selections as may be achieved by invocation of the onSelectTarget function at runtime. Such a configuration template may be (illustrative syntax only, actual syntax may be dependent on details of a particular implementation of the embodiments disclosed herein):

Parsing rules:

1) Identifier: pagebase

Pattern: page_base=‘\(.*\)’

2) Identifier: element

Pattern: TargetArray[.*]=‘\(.*\)’

Combination rules:

1) Apply on elements matched as type: ‘pagebase’

Create symbol name: PAGEBASE

Value: $(0)

2) Apply on elements matched as type: ‘element’

Value: $(PAGEBASE) +‘/’+$(0)

Output value as hyperlink

The first pattern parsing rule, 1), parses the data element which is the page_base variable value of the original script out. The associated combination rule, 1), stores this as a symbol named PAGEBASE (in this illustrative syntax, the terms $(<name>) are the values of the stored symbol, <name>, with the name, ‘0’, being a reserved name denoting the currently matched data element fed into the rule).

The second pattern parsing rule, 2), parses multiple data elements corresponding to the original values set into the TargetArray array in the original script. The associated combination rule, 2), combines these values with the PAGEBASE symbol value in the same manner as the function onSelectTarget in the original script, thereby arriving at the same eventual hyperlink targets as the original script. This structural similarity between originating script and combination rules is a common feature in practice although typical examples may be more complex than above. Because the script structure itself may not change as the content of the Website changes (i.e., new navigation targets are added and existing ones are changed), the configuration template may not need to change. Its production may, therefore, be a single task for any given Website structure.

In some embodiments, a method of parsing object code may include applying a functional transformation to the object code. The functional transformation may be applied as an independent step and/or as in combination with a data element identification or combination step.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for enumerating a hyperlinked data structure, comprising:
reading one or more data objects of a hyperlinked data structure through an object access interface;
parsing one or more data objects of the data structure;
identifying one or more data elements in one or more data objects;
combining two or more data elements to obtain one or more hyperlink addresses; and
reading one or more hyperlink addresses to enumerate one or more data objects.

2. The method of claim 1, wherein reading one or more data objects through an object access interface comprises reading one or more data objects over a network.

3. The method of claim 1, wherein reading one or more data objects through an object access interface comprises reading one or more data objects from a local memory medium.

4. The method of claim 1, wherein identifying one or more data elements comprises identifying one or more data elements according to at least one rule.

5. The method of claim 1, wherein identifying one or more data elements comprises identifying one or more data elements according to at least one rule, wherein at least one rules is associated with at least one configuration template.

6. The method of claim 1, wherein identifying one or more data elements comprises identifying one or more data elements according to at least one rule, wherein at least one rules is associated with at least one configuration template, and wherein the method further comprises selecting at least one configuration template based on a data object type of at least one data object.

7. The method of claim 1, wherein identifying the one or more data elements uses rules based on a data object type of the one or more data objects.

8. The method of claim 1, wherein identifying the one or more data elements uses rules based on grammar of a language of the one or more data objects.

9. The method of claim 1, wherein identifying the one or more data elements uses rules based on the structure of one or more data objects.

10. The method of claim 1, wherein identifying one or more data elements uses rules based on grammar of a language other than a language of the one or more data objects.

11. The method of claim 1, wherein identifying one or more data elements comprises pattern matching based on lexical rules.

12. The method of claim 1, wherein identifying one or more data elements comprises pattern matching based on lexical rules, wherein the lexical rules are specified using regular expressions.

13. The method of claim 1, wherein combining two or more data elements comprises combining two or more identified data elements.

14. The method of claim 1, wherein combining two or more data elements comprises combining one or more identified data elements and one or more fixed data elements.

15. The method of claim 1, wherein combining two or more data elements comprises combining one or more identified data elements and one or more fixed data elements, and wherein one or more fixed data elements are defined by a configuration template.

16. The method of claim 1, wherein combining two or more data elements comprises combining two or more data elements according to at least one rule.

17. The method of claim 1, further comprising applying at least one functional transformation to one or more data elements before combining two or more data elements.

18. The method of claim 1, wherein combining two or more data elements to obtain one or more hyperlink addresses comprises applying at least one functional transformation.

19. The method of claim 1, wherein identifying one or more data elements in one or more data objects and combining two or more data elements to obtain one or more hyperlink addresses comprises applying at least one functional transformation wherein at least one functional transformation identifies one or more data elements and combines one or more data elements to obtain one or more hyperlink addresses.

20. The method of claim 1, wherein combining two or more data elements comprises combining two or more data elements according to at least one rule, wherein at least one rule is defined by a configuration template.

21. The method of claim 1, wherein combining two or more data elements comprises combining two or more data elements according to at least one rule, wherein at least one rule is defined by a configuration template, and wherein the method further comprises selecting at least one configuration template based on a data object type of one or more data objects.

22. The method of claim 1, wherein combining two or more data elements comprises combining two or more data elements according to at least one rule, wherein the method further comprises selecting at least one rule based on a data object type of one or more data objects.

23. The method of claim 1, further comprising filtering one or more hyperlink addresses according to scoping rules.

24. The method of claim 1, wherein one or more hyperlink addresses comprise URLs.

25. The method of claim 1, wherein one or more hyperlink addresses comprise filenames.

26. The method of claim 1, wherein the data structure comprises a Website.

27. The method of claim 1, wherein the data structure comprises a file system.

28. A system configured to enumerate a hyperlinked data structure, comprising:
a network;
a CPU coupled to the network; and
a system memory coupled to the CPU, wherein the system memory stores one or more computer programs executable by the CPU;
wherein one or more computer programs are executable to:
read one or more data objects of a hyperlinked data structure through an object access interface;
parse the one or more data objects of the data structure;
identify one or more data elements in one or more data objects;
combine two or more data elements to obtain one or more hyperlink addresses; and
read one or more hyperlink addresses to enumerate one or more data objects.

29. A carrier medium comprising program instructions, wherein the program instructions are executable to implement a method for enumerating a hyperlinked data structure on a computer system, the method comprising:
reading one or more data objects of a hyperlinked data structure through an object access interface;
parsing one or more data objects of the data structure;
identifying one or more data elements in one or more data objects;
combining two or more data elements to obtain one or more hyperlink addresses; and
reading one or more hyperlink addresses to enumerate one or more data objects.
